(19) United States
(12) Patent Application Publication
(10) Pub. No.: US 2017/0268875 A1
(43) Pub. Date: Sep. 21, 2017

(54) Range Finder Capable of Adjusting Light Flux

(71) Applicants: Sintai Optical (Shenzhen) Co., Ltd., Shenzhen- City (CN); Asia Optical Co., Inc., Taichung (TW)

(72) Inventors: Hsien-Chi Lin, Taichung (TW); Pin-Ying Wu, Taichung (TW)

(21) Appl. No.: 15/425,084

(22) Filed: Feb. 6, 2017

(30) Foreign Application Priority Data
Mar. 15, 2016 (CN) 201610146570.0

(51) Int. Cl. G01C 11/02; G02B 5/00; G01C 3/08

(52) U.S. Cl. CPC G01C 11/02; G01C 3/08; G02B 5/003

(57) ABSTRACT

A range finder capable of adjusting light flux includes a light-emitting element configured to emit a light beam, a lens element, a light-shielding element configured to adjust light flux, and an image sensor. The light beam emitted by the light-emitting element is reflected by an object, passes through the lens element, and is projected to the image sensor. The light-shielding element is disposed between the object and the image sensor, and on a path of the light beam.

### BACKGROUND OF THE INVENTION

Field of the Invention

The invention relates to a range finder, and more particularly to a range finder which is capable of adjusting light flux.

Description of the Related Art

FIGS. 1A and 1B respectively depict a prior range finder 10 which is used for measuring a distance to a near object 20 and a distant object 30. The prior range finder 10 includes a light-emitting element 12, a lens element 14, an optical filter 16 and an image sensor 18. In a measurement of a distance from the range finder 10 to a near object 20, as shown in FIG. 1A, a light beam emitted by the light-emitting element 12 is reflected by the near object 20, passes through the lens element 14 and the optical filter 16, and is projected to the image sensor 18. In a measurement of a distance from the range finder 10 to a distant object 30, as shown in FIG. 1B, a light beam emitted by the light-emitting element 12 is reflected by the distant object 30, passes through the lens element 14 and the optical filter 16, and is projected to the image sensor 18.

The optical filter 16 is configured to filter out an undesirable part from the light beam so that the light beam arriving at the image sensor 18 has the same wavelength as the light beam emitted by the light-emitting element 12. FIG. 2 depicts the optical filter 16 through which two light beams pass, wherein a reflecting light beam 21 of the near object and a reflecting light beam 31 of the distant object are simultaneously shown on the optical filter 16 for a convenient comparison. As shown, the reflecting light beam 21 of the near object passes through the left portion of the optical filter 16, and the reflecting light beam 31 of the distant object passes through the right portion of the optical filter 16.

In practical application, however, accuracy of distance measurement by the prior range finder is not satisfactory.

### BRIEF SUMMARY OF THE INVENTION

According to a study, the flux of a light beam reflected by a near object is occasionally excessive so that the signal received by the image sensor is saturated and the distance measurement is inaccurate. To address the problem, the invention provides a range finder for adjusting the flux of the light beam reflected by the near object, without affecting the flux of the light beam reflected by a distant object.

The range finder in accordance with an embodiment of the invention includes a light-emitting element, a lens element, a light-shielding element and an image sensor. The light-emitting element is configured to emit a light beam, and the light-shielding element is configured to adjust light flux. The light beam emitted by the light-emitting element is reflected by an object, passes through the lens element, and is projected to the image sensor. The light-shielding element is disposed between the object and the image sensor, and on a path of the light beam

In another embodiment, the light-shielding element is disposed in front of, within or behind the lens element.

In another embodiment, the light beam reflected by the object is partly blocked by the light-shielding element, and a proportion of the light beam blocked by the light-shielding element depends on a distance from the object to the range finder.

In another embodiment, the light-shielding element has contact with the image sensor.

In another embodiment, the light-shielding element is printed on the image sensor.

In another embodiment, the light-shielding element and the image sensor are spaced.

In another embodiment, the range finder further includes an optical filter disposed in front of the image sensor or the lens element.

In another embodiment, the light-shielding element has contact with the optical filter.

In another embodiment, the light-shielding element is printed on the optical filter.

In another embodiment, the light-shielding element and the optical filter are spaced.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1A depicts a measurement of a distance from a prior range finder to a near object by the prior range finder;

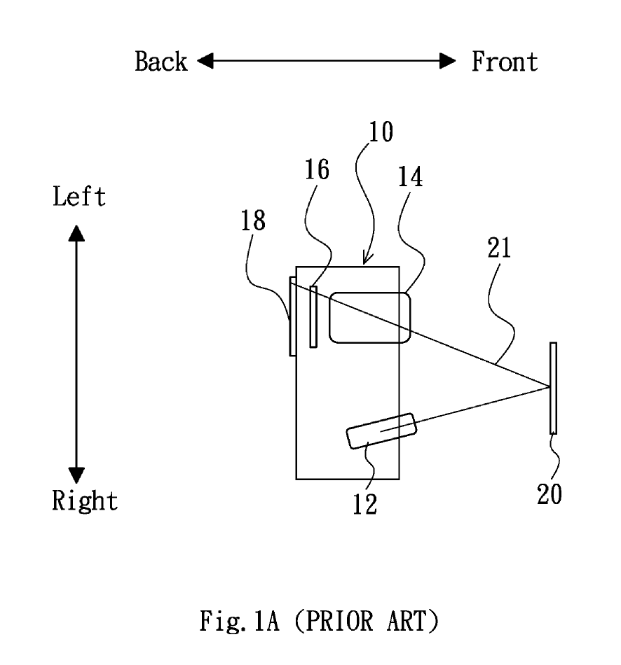

FIG. 1B depicts a measurement of a distance from a prior range finder to a distant object by a prior range finder;

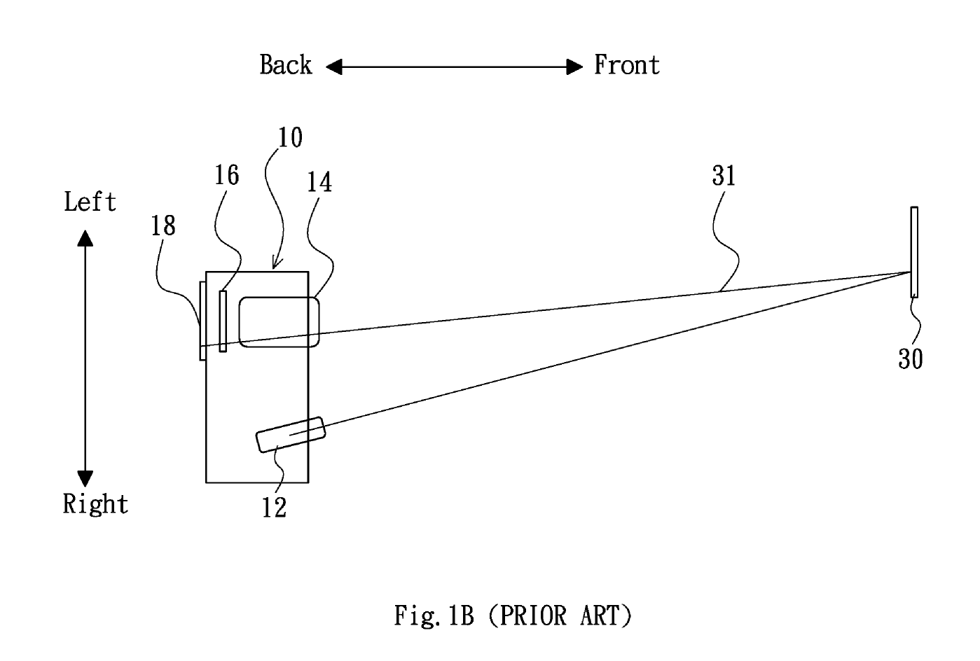

FIG. 2 depicts an optical filter through which light beams reflected by the near object and the distant object of FIGS. 1A and 1B simultaneously pass;

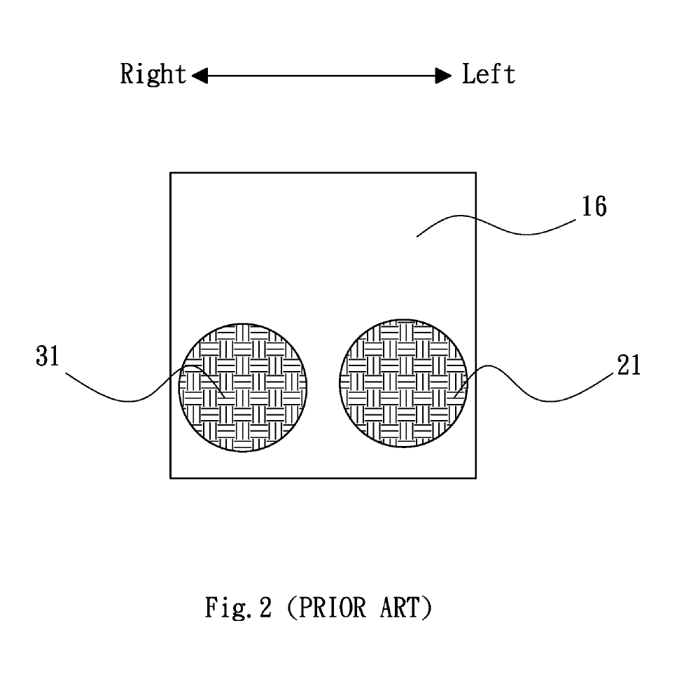

FIG. 3A is a perspective view of a range finder measuring a distance from the range finder to a near object in accordance with an embodiment of the invention;

FIG. 3B is a top view of the FIG. 3A;

FIG. 4 is a plan view of the range finder in FIGS. 3A and 3B measuring a distance from the range finder to a distant object;

FIG. 5A is a perspective view of a range finder measuring the distance from the range finder to a distant object in accordance with another embodiment of the invention; and

FIG. 5B is a top view of the FIG. 5A.

### DETAILED DESCRIPTION OF THE INVENTION

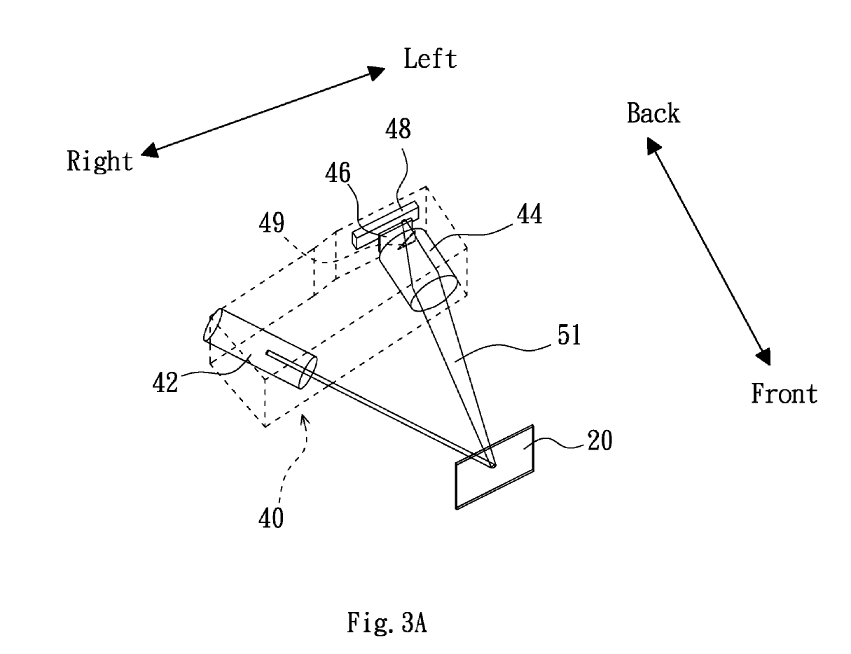

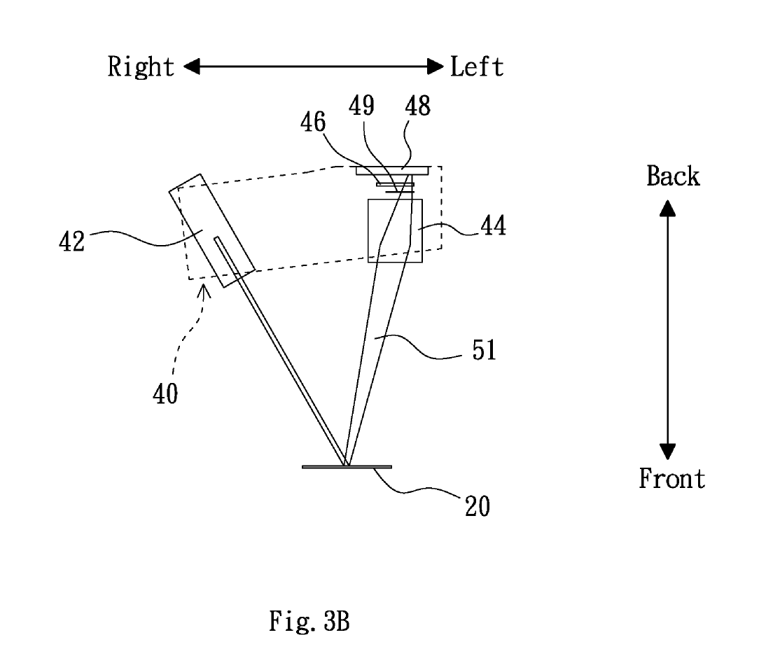

FIGS. 3A and 3B depict a range finder measuring a distance to a near object in accordance with an embodiment of the invention, wherein the directions “front”, “back”, “left”, and “right” are represented for easy descriptions below. Further, all elements in FIGS. 3A and 3B are shown only for the purpose of easy understanding. Therefore, the structural detail of the elements may be omitted. For example, the lens element 44 has a spacer ring (a light-receiving element) which is not shown in FIGS. 3A and 3B. In present embodiment, a range finder 40 includes a light-emitting element 42, a lens element 44, a light-shielding element 49, an optical filter 46 and an image sensor 48. In a measurement of a distance from the range finder 40 to a near object 20, a light beam emitted by the light-emitting element 42 is reflected by the near object 20, passes through the lens element 44 and the optical filter 46, and is projected to the image sensor 48. The optical filter 46 is configured to filter out an undesirable part from the light beam, wherein the wavelengths of the undesirable part of the light beam are different from that of the light beam emitted by the light-emitting element 42. Thus, the light beam arriving at the image sensor 48 has the same wavelength as originally emitted by the light-emitting element 42.

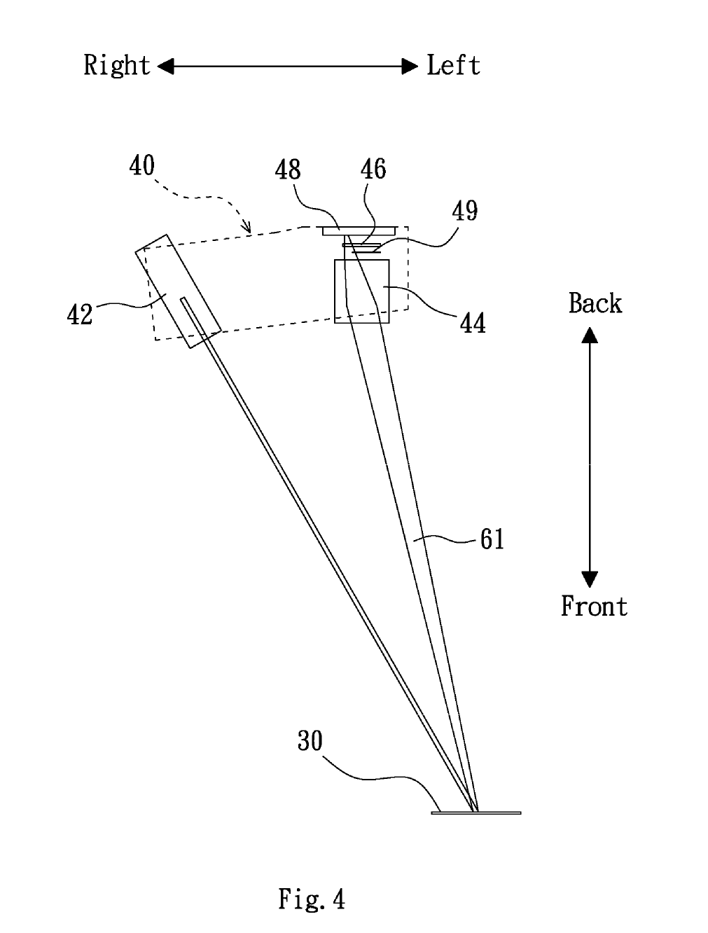

FIG. 4 depicts the range finder 40 measuring a distance to a distant object 30. In a measurement of a distance from the range finder 40 to a distant object 30, a light beam emitted by the light-emitting element 42 is reflected by the distant object 30, passes through the lens element 44 and the optical filter 46, and is projected to the image sensor 48. If the distant object is located farther, then the light beam is reflected more to the right, even without passing through the light-shielding element 49.

A study shows that an excessive light flux received by the image sensor 48 will result in an inaccurate measurement of distance. In present embodiment, therefore, the light-shielding element 49 is disposed behind the left portion of the lens element 44 to partly block a reflecting light beam 51 of the near object 20. By this arrangement, the problem of inaccurate measurement of distance resulting from excessive light flux can be solved and the flux of the light beam reflected by the distant object is not over-decreased. As shown in FIG. 4, the light-shielding element 49 is disposed behind the left portion of the lens element 44 to partly block a reflecting light beam 61 of the distant object 30.

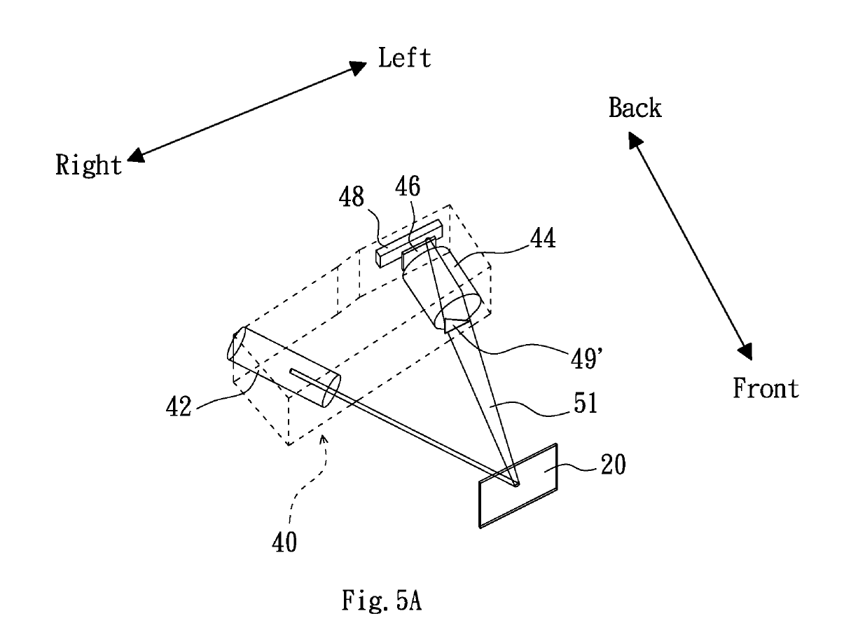

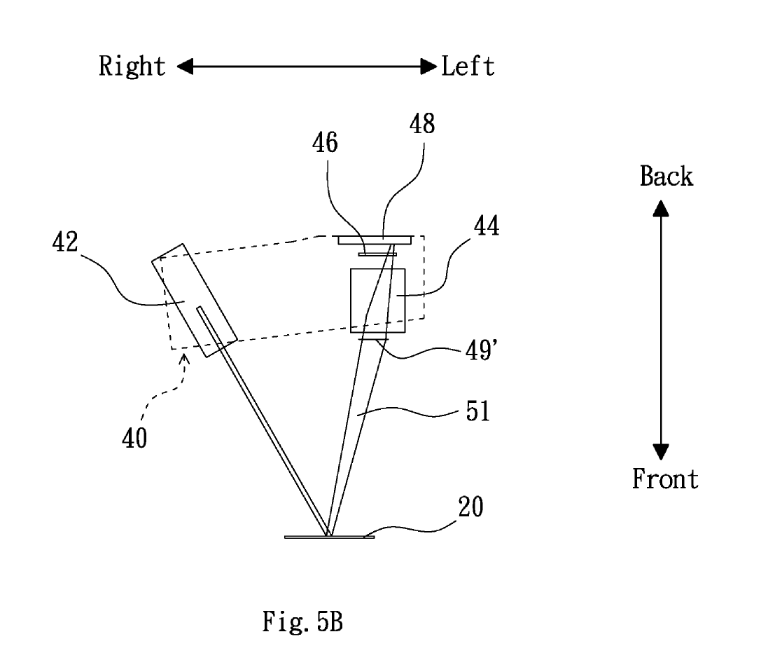

FIGS. 5A and 5B depict a range finder 40 measuring a distance to a near object 20 in accordance with another embodiment of the invention. Since all elements except a light-shielding element 49′ in FIGS. 5A and 5B are the same as those in FIGS. 3A and 3B, all elements except the light-shielding element 49′ in FIGS. 5A and 5B are not described here. In present embodiment, the light-shielding element 49′ is disposed in front of the right portion of the lens element 44 to partly block a reflecting light beam 51 of the near object 20. By this arrangement, the problem of inaccurate measurement arising from excessive flux of the light beam reflected by a near object can be solved. Moreover, the flux of the light beam reflected by a distant object is not over-decreased. It is understood that the light-shielding element 49′ disposed in front of the right portion of the lens element 44 is able to partly block a reflecting light beam 61 of the distant object 30 (not shown).

It is worth noting that the proportion of the light beam blocked by the light-shielding element depends on a distance from the object to the range finder.

In the embodiment described above, the light-shielding element is disposed in front of or behind the lens element 44 to decrease the flux of the light beam reflected by an object. However, it is understood that the light-shielding element can be disposed within the lens element 44 to decrease the flux of the light beam reflected by the object.

It is understood that the position of the light-shielding element requires to be changed from the left to the right (or from the right to the left) when the positions of the light-emitting element 42 and the image sensor 48 are exchanged.

In the embodiment described above, the light-shielding element is disposed in front of or behind the lens element, and the light-shielding element and the lens element are spaced. However, it is understood that the light-shielding element can be attached to the lens element to decrease the flux of the light beam reflected by the near object or the distant object.

It is understood that the light-shielding element can be disposed in front of or behind the optical filter 46, and is attached to or spaced from the optical filter 46 to decrease the flux of the light beam reflected by an object.

In some embodiments, the light-shielding element is printed on the optical filter 46 to partly block the reflecting light beam 51 of the near object (or the reflecting light beam 61 of the distant object) projected to the image sensor 48.

In some embodiments, the light-shielding elements 49 and 49′ are made of an opaque material.

In other embodiments, the light-shielding elements 49 and 49′ are made of a translucent material.

In other embodiments, the light-shielding elements 49 and 49′ are made of a material with graduated transparency.

The light-shielding element is not limited to be triangular. On the contrary, the light-shielding element can be trapezoidal or in other shapes. For example, a light-shielding element made of the material with graduated transmittance can be rectangular. It is noted that a rectangular light-shielding element of lower transmittance requires to be located closer to a light path of the light beam reflected by the near object. For another example, the light-shielding element can be a frame body which defines a hole allowing the light beam to pass through. A light-shielding element with a smaller hole requires to be located closer to a light path of the light beam reflected by the near object. In short, any shape or style of light-shielding element which is able to partly block the light beams reflected by the near object and the distant object in different proportions is applicable to this invention.

Further description is provided for a better understanding of the range finder of the invention. A device capable of scanning environment, which may be but not limited to a domestic robot, a robotic pet (e.g. a robotic dog) or an autonomous car with a laser scanning or a light detection and ranging (LiDAR), usually includes a distance measuring device and an imaging device. The distance measuring device configured to measure distance to an object includes the light-emitting element described above. The imaging device includes the image sensor described above and the lens element described above. The light-shielding element described above is disposed between the to-be-measured object and the image sensor, and on a path of a light beam emitted by the light-emitting element. A signal received from the image sensor is transmitted to a processing unit for analyzing the surroundings. Furthermore, the processing unit is electrically connected to a moving unit configured to move the device capable of scanning environment, and therefore the device capable of scanning environment is moved according to the condition of its surroundings. The light-emitting element may be but not limited to a laser source or an infrared source. The image sensor may be but not limited to a Charge-Coupled Device (CCD) or a Complementary Metal-Oxide-Semiconductor (CMOS). The moving unit includes a driving device (such as but not limited to a motor or an engine), a transmission (such as but not limited to belts, gears and/or gear boxes), and a steering mechanism (such as but not limited to wheels or tracks).

What is claimed is:

1. A range finder capable of adjusting light flux, comprising:
a light-emitting element configured to emit a light beam;
a lens element;
a light-shielding element configured to adjust light flux; and
an image sensor;
wherein the light beam emitted by the light-emitting element is reflected by an object, passes through the lens element, and is projected to the image sensor;
wherein the light-shielding element is disposed between the object and the image sensor, and on a path of the light beam.

2. The range finder capable of adjusting light flux as claimed in claim 1,
wherein the light-shielding element is disposed in front of the lens element.

3. The range finder capable of adjusting light flux as claimed in claim 1,
wherein the light-shielding element is disposed within the lens element.

4. The range finder capable of adjusting light flux as claimed in claim 1,
wherein the light-shielding element is disposed behind the lens element.

5. The range finder capable of adjusting light flux as claimed in claim 1,
wherein the light-shielding element is contacted in front of the lens element.

6. The range finder capable of adjusting light flux as claimed in claim 1,
wherein the light-shielding element is contacted behind the lens element.

7. The range finder capable of adjusting light flux as claimed in claim 1,
wherein the light beam reflected by the object is partly blocked by the the light-shielding element depends on a distance from the object to the range finder.

8. The range finder capable of adjusting light flux as claimed in claim 1,
wherein the light-shielding element is contacted with the image sensor.

9. The range finder capable of adjusting light flux as claimed in claim 8,
wherein the light-shielding element is printed on the image sensor.

10. The range finder capable of adjusting light flux as claimed in claim 1,
wherein the light-shielding element and the image sensor are spaced.

11. The range finder capable of adjusting light flux as claimed in claim 1,
further comprising an optical filter disposed in front of the image sensor.

12. The range finder capable of adjusting light flux as claimed in claim 1,
further comprising an optical filter disposed in front of the lens element.

13. The range finder capable of adjusting light flux as claimed in claim 11,
wherein the light-shielding element is contacted with the optical filter.

14. The range finder capable of adjusting light flux as claimed in claim 12,
wherein the light-shielding element is contacted with the optical filter.

15. The range finder capable of adjusting light flux as claimed in claim 13,
wherein the light-shielding element is printed on the optical filter.

16. The range finder capable of adjusting light flux as claimed in claim 14,
wherein the light-shielding element is printed on the optical filter.

17. The range finder capable of adjusting light flux as claimed in claim 11,
wherein the light-shielding element and the optical filter are spaced.

18. The range finder capable of adjusting light flux as claimed in claim 12,
wherein the light-shielding element and the optical filter are spaced.
